(19) United States
(12) Patent Application Publication
(10) Pub. No.: US 2008/0028650 A1
(43) Pub. Date: Feb. 7, 2008

(54) Method and apparatus for displaying personalized information on a vehicle

(75) Inventor: Peter W. Ratcliffe, Stevenson, MD (US)

Correspondence Address: NATH & ASSOCIATES, 112 South West Street, Alexandria, VA, 22314, US

(73) Assignee: HoodEz LLC, Stevenson, MD (US)

(21) Appl. No.: 11/798,835

(22) Filed: May 17, 2007

Related U.S. Application Data
(63) Continuation-in-part of application No. 11/392,559, filed on Mar. 30, 2006.
(60) Provisional application No. 60/783,439, filed on Mar. 20, 2006.

(51) Int. Cl. G09F 21/04

(52) U.S. Cl. 40/591

(57) ABSTRACT

A way for a consumer to display personalized information is provided as a display device for displaying the personalized information or other objects, and an attachment mechanism that attaches the display device to a vehicle by way of a base and that is also detachable from the base. The personalized information may be placed on or inside the display device for the consumer, or the consumer may place the personalized information on or inside the display device himself. The personalized information may represent military affiliation, authorization, or may be any other personalized image or text. The base may be affixed to the vehicle by way of a magnet or other mechanism. The display device may include a recess for holding a can or cup. The display device may be pivoted relative to the base so that the display device may be displayed perpendicular or parallel to a plane defined by the vehicle's wheels.

### CROSS-REFERENCE TO RELATED APPLICATIONS

This application is a continuation-in-part of U.S. patent application Ser. No. 11/392,559, filed Mar. 30, 2006, currently pending, which itself claims the benefit of U.S. Provisional Patent Application No. 60/783,439, filed Mar. 20, 2006. The contents of these U.S. patent application Ser. Nos. 11/392,559 and 60/783,439 are hereby incorporated by reference in their entirety.

### BACKGROUND OF THE INVENTION

1. Field of the Invention

The present application relates to methods and apparatuses for displaying personalized information on a vehicle, and specifically to personalized hood ornaments and other personalized vehicle-mounted display devices, and to a pivotable mount for hood ornaments and other personalized vehicle-mounted display devices.

2. Related Art

Consumers are constantly seeking new ways to show that they like or are affiliated with an entity. Many such displays involve entities which are personal to the consumer, such as family members, friends, branches or units of the military, employers, coworkers, pets, trips, locales, events, private sayings, in-jokes, political commentary, religions, affinities, charities, environmental causes, or promotional interests. Methods for displaying a customized, personalized liking or affiliation have heretofore involved the purchase of items such as t-shirts, buttons, and labels. These items can sometimes be customized with the use of a home computer, or through an online service.

Methods for displaying information on a vehicle, such as bumper stickers, roof placards, and standard factory-mounted hood ornaments, are replete with problems and inconveniences such as the need for permanent modification of the vehicle, the risk of vehicle damage, the need for cumbersome equipment to secure a display to a vehicle, and generally unattractive ornamentation. The existing semi-permanent methods for displaying information on a vehicle thus make vehicle owners reluctant to display a customized, personalized liking or affiliation on their vehicles.

Personalized vehicle ornamentation is not known in the art, because pre-existing hood ornaments, and lesser devices such as bumper stickers, are often inconvenient to remove, replace or modify. The traditional hood ornament is provided by the manufacturer of the vehicle at the time of manufacture, and represents the make of the vehicle to which it is attached. Typically, the traditional hood ornament is attached to the vehicle in a semi-permanent manner (such as a hook and spring mechanism) which is not detachable without special tools and professional expertise. Even when the traditional hood ornament can be removed from its attachment mechanism, there is no guarantee that a replacement ornament other than one made by the vehicle manufacturer will be capable of attachment using the original attachment mechanism. Further, removal of the manufacturer-supplied ornament typically leaves on the hood a hole or an unornamented mount; neither is attractive, and both can quickly become clogged with dirt and debris under normal road conditions. Similarly, the removal of a bumper-sticker (when this is even possible), which itself is only two-dimensional, typically leaves on the vehicle an unattractive stain which can quickly become an adherent for dirt and debris under normal road conditions.

Moreover, vehicle owners whose vehicles lack ornaments are reluctant to permanently modify their vehicles with a conspicuous and difficult-to-remove ornament which, however personal, may not be suited for all occasions.

Further, vehicle ornamentation which accounts for non-level surfaces of a vehicle, that would otherwise place an ornament at an unattractive angle relative to an observer, is unknown in the art.

In this way, one can think of the vehicle as a space for displaying attachable, removable and interchangeable personalized information that, until this subject matter, has not been used. One can also think of vehicle ornamentation as a way for an individual to display a personalized liking or affiliation which has heretofore been too mechanically complex and too permanent in its affixation to allow for easy, repeatable display, and which has required a permanent modification affecting the original condition of the vehicle.

### SUMMARY OF THE INVENTION

The present subject matter addresses the above concerns by teaching the following methods and apparatuses.

In one aspect, the present subject matter relates to a method of enabling a consumer to display information personalized to him or her. The method involves providing the consumer with a display device for displaying the personalized information, and providing the consumer with an attachment mechanism. The attachment mechanism attaches the display device to a vehicle by way of a base affixed to the vehicle, and is also detachable from the base.

Examples of display devices include, without limitation, picture frames, low-profile medallions, vertical medallions, flags, and other three-dimensional figures.

Example locations for placement of the base include, without limitation, the dashboard of the vehicle, the inside of a window of the vehicle, the outside of a window of the vehicle, the roof of the vehicle, the hood of the vehicle, the trunk of the vehicle, the bumper of the vehicle, the tailgate of the vehicle, and the trailer hitch of the vehicle.

Example vehicles include, without limitation, cars, light trucks, sports utility vehicles, trucks, military vehicles, motorcycles, and boats.

The personalized information may be placed on or in the display device for the consumer. This may be accomplished by receiving a representation of the personalized information from the consumer, and configuring the display device to display the personalized information before providing the display device to the consumer. Digital data may be received by way of a web site at which the consumer may upload a representation of personalized information, or may be received by other media. The digital data may include, without limitation, photographs, drawings, text, symbols, electronics, or combinations of these.

Alternatively, the consumer may place the personalized information on the display device or inside the display device himself. This may, although need not necessarily, be accomplished by receiving a first representation of the personalized information from the consumer, and in return, providing the consumer with a second representation of the personalized information, the second representation configured for placement on or in the display device. The consumer, having already been provided with the display device, may then place the representation of the personalized information on or in the display device. The digital data may be received by way of a web site at which the consumer may upload a representation of personalized information, or may be received by other media. The digital data may include, without limitation, photographs, drawings, text, symbols, electronics, or combinations of these.

In another aspect, the personalized information may represent a military affiliation. The display device may be, without limitation, a three-dimensional military symbol, a two-dimensional military symbol, a picture frame containing military-related indicia, a low-profile medallion displaying military-related indicia, a vertical medallion displaying military-related indicia, a representation of award or rank, or a flag displaying military-related indicia.

In another aspect, the personalized information may represent authorization to perform a certain task. Examples of these authorizations include, without limitation, handicap parking permits, campus parking permits, parking permits generally, residential permits, entry permits, RFID permits such as E-Z Pass, and other forms of authorized identification.

In another aspect, the display device may include a recess configured to hold an object. The object may be a can or cup.

In another aspect, the present subject matter relates to a device which enables a consumer to display information personalized to the consumer. The device includes a display mechanism in which (or on which) the personalized information may be placed, and an attachment mechanism that attaches the display mechanism to a vehicle by way of a base affixed to the vehicle. The attachment mechanism is detachable from the base.

In some forms, the display mechanism includes a plate attached to the attachment mechanism, and a cover. The personalized information, which may be provided by the consumer or by the vendor, is placed between the plate and the cover. The cover comprises a transparent element through which the personalized information may be seen.

In some forms, the base is attached to the vehicle by way of a magnet. This is only one example of an attachment system, and others may be used, such as a light tack adhesive layer, screws, rivets, or a permanently bolted base. All of these base attachments still allow for the interchangeability of an attachment mechanism of a display device.

In some aspects the base may be easily placed on the dashboard of the vehicle, the inside of a window of the vehicle, the outside of a window of a vehicle, the roof of the vehicle, the hood of the vehicle, the trunk of the vehicle, the bumper of the vehicle, the tailgate of the vehicle, and the trailer hitch of the vehicle. In another aspect, however, the consumer may wish to use a base which can be even more easily placed inside a vehicle. Accordingly, the present subject matter also relates to a base to which a display device may be attached and from which it may be detached. The base includes a plate from which a plurality of extensions protrude, a corresponding plurality of recesses beneath the plurality of extensions for receiving at least one foot protruding from the display device, and a protrusion extending from the plate and configured for placement in the cup holder of a vehicle. To facilitate placement in the cup holder of a vehicle, the sides of the protrusion may be tapered inward at increasing distance from the plate.

In another aspect, the present subject matter relates to an attachment mechanism that attaches an object to a non-level vehicle surface at an angle. The attachment mechanism, which is detachable from the base, includes a support fixedly connected to the object and pivotably connectable to the vehicle at the surface such that the object may be held at a pivoted angle relative to the surface. The object may be a display device according to the present subject matter, such as an ornament, frame, flag, medallion, or any other appropriate object. The attachment mechanism may attach by way of a base, and may include a plate connected to the support; and at least one foot connected to the plate. The base has one or more extensions protruding therefrom, and each foot is feedable into a recess beneath an extension. In this way, the pivotable connection of the plate and support allows the display device to pivot relative to the base. The plate may be pivotably connected to the support by way of a ratcheting disk. The support may be pivoted relative to the base so that the display device may be displayed perpendicular to a plane defined by the vehicle's wheels when the base is attached to a vehicle surface that is not parallel to the plane defined by the vehicle's wheels.

### BRIEF DESCRIPTION OF THE DRAWINGS

The features, nature, and advantages of the presently disclosed methods and apparatuses will become more apparent from the detailed description set forth below when taken in conjunction with the drawings in which like reference characters identify corresponding items throughout and wherein:

FIG. 1 charts a method of enabling a consumer to display information personalized to the consumer according to the present disclosure.

FIG. 2 charts another method of enabling a consumer to display information personalized to the consumer according to the present disclosure.

FIGS. 3a and 3b illustrate an aspect of a device which enables a consumer to display information personalized to the consumer according to the present disclosure.

FIG. 4 illustrates a base disposed on a vehicle according to the present disclosure.

FIG. 5 illustrates a display device disposed at the base of FIG. 4.

FIG. 6 illustrates an attachment mechanism and base according to the present disclosure.

FIG. 7 illustrates another aspect of a device which enables a consumer to display information personalized to the consumer according to the present disclosure.

FIG. 8 illustrates another aspect of a device which enables a consumer to display information personalized to the consumer according to the present disclosure.

FIG. 9 illustrates an aspect of a device which enables a consumer to display military-related information personalized to the consumer according to the present disclosure.

FIG. 10 illustrates an aspect of a device which enables a consumer to display an authorization according to the present disclosure.

FIG. 11 illustrates another aspect of a base to which a display device may be attached according to the present disclosure.

FIG. 12 illustrates another aspect of a base to which a display device may be attached according to the present disclosure.

FIG. 13 illustrates the base of FIG. 12 disposed in the cup rest of a vehicle.

FIG. 14 illustrates the base of FIG. 13 with a display device attached.

FIG. 15 illustrates an aspect of a base to which a display device may be attached according to the present disclosure.

FIG. 16 illustrates the base of FIG. 15 with a display device attached.

FIG. 17 illustrates a mechanism for providing a plurality of display devices according to the present disclosure.

FIG. 18 illustrates another aspect of a device which enables a consumer to display information personalized to the consumer according to the present disclosure.

FIG. 19a is an illustration of a front view of a device which enables a consumer to display information, the device being unpivoted.

FIG. 19b is an illustration of a side view of the device of FIG. 19a.

FIG. 19c is an illustration of a perspective view of the device of FIG. 19a.

FIG. 20 is an illustration of a front view of the device of FIG. 19a, the device having been pivoted.

FIG. 20b is an illustration of a side view of the device of FIG. 20a.

FIG. 20c is an illustration of a perspective view of the device of FIG. 20a.

FIG. 21 is an illustration of an operational environment for the device of FIG. 20a.

FIG. 22 is an illustration of a device according to FIG. 19a, the device disassembled.

FIG. 23 is an illustration of another aspect of a device which enables a consumer to display information personalized to the consumer, including a recess configured to hold an object such as a can or cup.

FIG. 24. is an illustration of the device of FIG. 23 disposed on an inside surface of a vehicle.

### DETAILED DESCRIPTION

In one aspect, the present subject matter relates to techniques for enabling a consumer to display personalized information on a vehicle. These techniques involve the use of a base which is disposed at the consumer's vehicle, and to which a device that displays the personalized information may be attached and detached by way of an attachment mechanism. The base may be attached to the vehicle by an adhesive or by another mechanism. If the consumer provides the personalized information (for example, by uploading it at a web site of a device provider), the display device and attachment mechanism may together be shipped to the consumer preconfigured to display the personalized information. In this case, techniques may be implemented to screen the provided information for offensive content, for copyrighted content in which the consumer holds no rights, or for trademarked images or other images which run afoul of existing legal guidelines.

In an alternative aspect, a display device and attachment mechanism may be provided to the consumer with no preconfiguration, and the user may personally configure the display device to display the personalized information. The display device may be shaped to receive a photo or printed sheet, and the consumer may be provided with special paper such as bumper sticker paper, laminated paper, or otherwise water-resistant paper, for printing his or her own personalized information. The device may be designed to protect the personalized information, and the user may be encouraged to use a plurality of devices to attach and detach different pieces of personalized information.

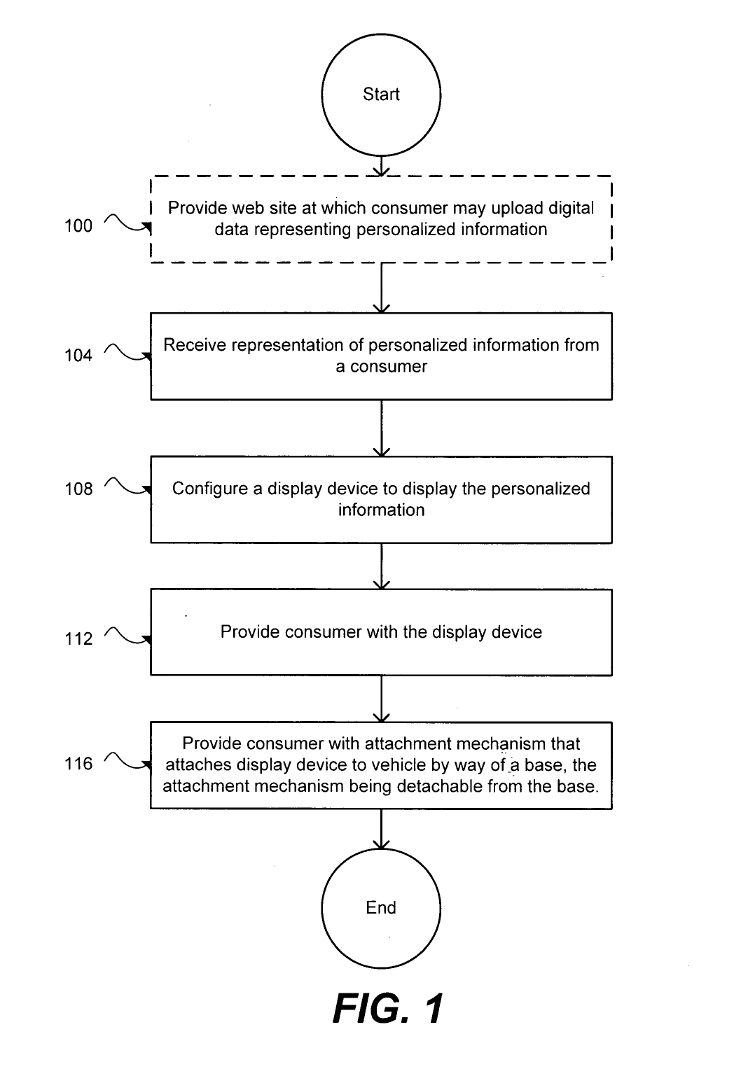

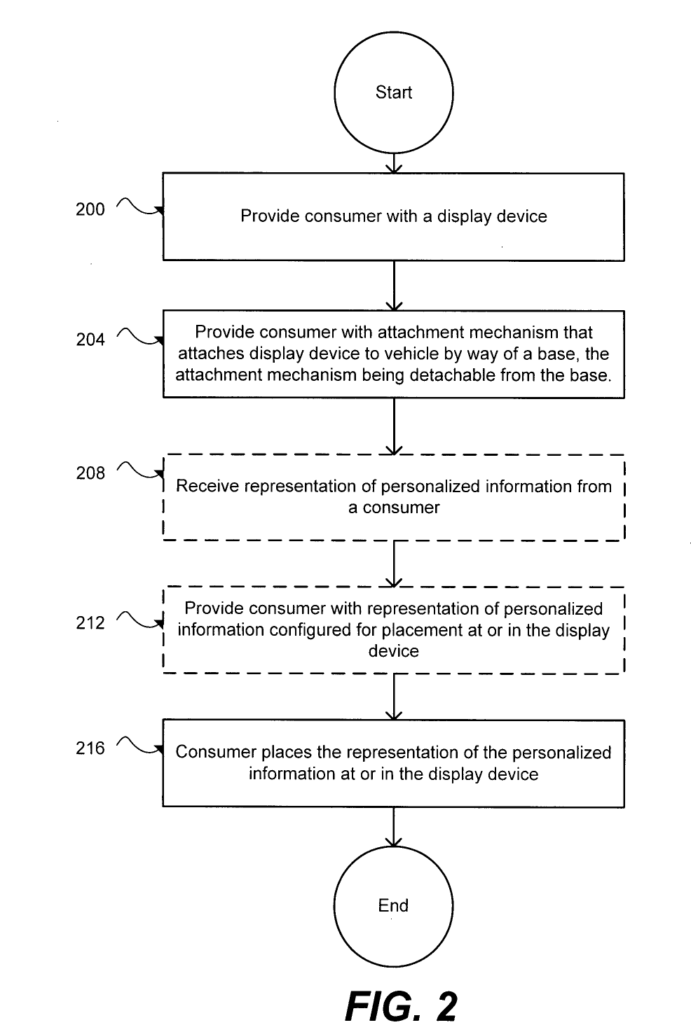

The above two techniques will now be discussed with reference to FIGS. 1 and 2. In FIG. 1, a representation of personalized information is received (step 104) from a consumer. Many kinds of personalized information may be received at this step. The personalized information may include, without limitation, photographs, drawings, text, symbols, electronics, and combinations thereof. The term “personalized” may in some aspects refer to information which relates to the consumer in a personal way. Non-limiting examples of this personalized information include photographs, drawings, or images of the consumer, the consumer's family members, the consumer's pets, or the consumer's coworkers; images and text commemorating the consumer's age, success, or travels; private sayings or in-jokes to which the consumer is privy; and political commentary made by the consumer. The personalized information may involve entities which are personal to the consumer, such as, without limitation, family members, friends, branches or units of the military, employers, coworkers, pets, trips, locales, events, private sayings, in-jokes, political commentary, religions, affinities, charities, environmental causes, or promotional interests. These are merely examples, however, and the term personalized may be construed to include any information which the consumer possesses and/or information which relates to the consumer, and which is to be displayed on his vehicle, according to the technique(s) disclosed herein.

Once received, a display device may be configured (step 108) to display the personalized information. In some techniques, this configuration may involve printing the personalized information (again, such as a photograph or text) onto a surface, and then placing the printed-on surface in or on the display device. Alternatively, the personalized information may be printed directly onto the display device, or the display device may be molded or formed into a shape corresponding to the personalized information. These are merely examples, and other configurations may be used.

Once configured, the display device may be provided to the consumer (step 112), along with an attachment mechanism (step 1116). The attachment mechanism is particularly shaped to attach the display device to a vehicle by way of a base affixed to the vehicle, and to be detachable from the base. In this way, the display device and attachment mechanism may be detached from the base, and replaced with a different display device and attachment mechanism. As a non-limiting example, the consumer may use one display device during the week and another on the weekends, the week's display device displaying personalized information corresponding to the consumer's job, and the weekend's display device displaying personalized information corresponding to the consumer's family. Attachment and detachment occur with no permanent change or damage to the vehicle, so any number of personalized display devices and attachment mechanisms may be used, and it is expected that the consumer will possess more than one display device, and may even possess one or more advertisements which utilize the same base.

In some aspects, digital data representing personalized information may be uploaded directly by the consumer (step 100) at a web site operated or managed by the device provider. This is merely one example, however, and a representation of the personalized information may be provided in other ways: as non-limiting examples, the consumer may mail photographs or text to the device provider; a representation of the personalized information about the consumer may be provided by a third party, as when giving a gift or when direct marketing; or, a representation of the personalized information may be read over the phone.

In the above aspects, the display device is provided to the consumer preconfigured to display personalized information. FIG. 2 charts alternative aspects in which the consumer (step 216) places the representation of the personalized information on or in the display device himself or herself. The method begins by providing the consumer with a display device (step 200). The display device may be sold in stores, may be provided promotionally, or may be ordered from, or provided by, a provider by any other method. The display device is provided with an attachment mechanism (step 204) which, as described above, attaches to and detaches from a vehicle by way of a base affixed to the vehicle. In some aspects, the display device is designed so that the consumer may directly place a representation of the personalized information on or in the display device (step 216). For example, a display device may be provided in the form of a picture frame, into which the client may slide or otherwise secure a picture or other information-bearing item. The frame or similar device may be provided preassembled and configured to receive a picture, or the consumer may snap or otherwise assemble the device into a form for holding the picture. The frame is connected to the attachment mechanism, and thus can attach to, and detach from, a base disposed on a vehicle. In other aspects, the display device is designed so that the consumer first provides a representation of the personalized information to the device provider or another party (step 208). The device provider (or other party) then uses this representation to prepare a further representation of the personalized information, configured for placement on or in the display device (step 212). As a non-limiting example, the consumer may provide a photograph to the device provider or other party, who then prints the photograph onto a plate which is manufactured to fit into the display device. This plate is then provided to the consumer, who may place it into the display device and then place the display device at his vehicle by way of the attachment mechanism.

Examples of display devices according to the above techniques will now be described, including picture frames, low-profile medallions, vertical medallions, flags, and three-dimensional figures. Any or all of these devices may be utilized in either of the methods described above, in which the display device is preconfigured by the device provider or other party to display personalized information provided by the consumer, or alternatively in which the display device is configured by the consumer to display the personalized information.

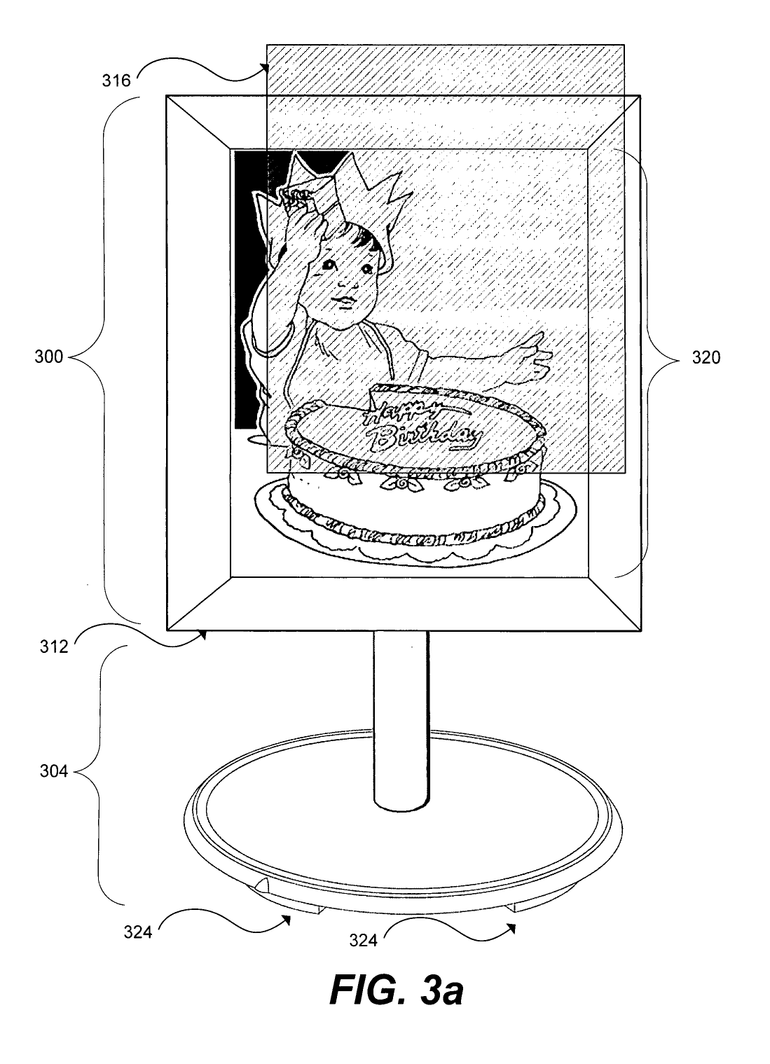

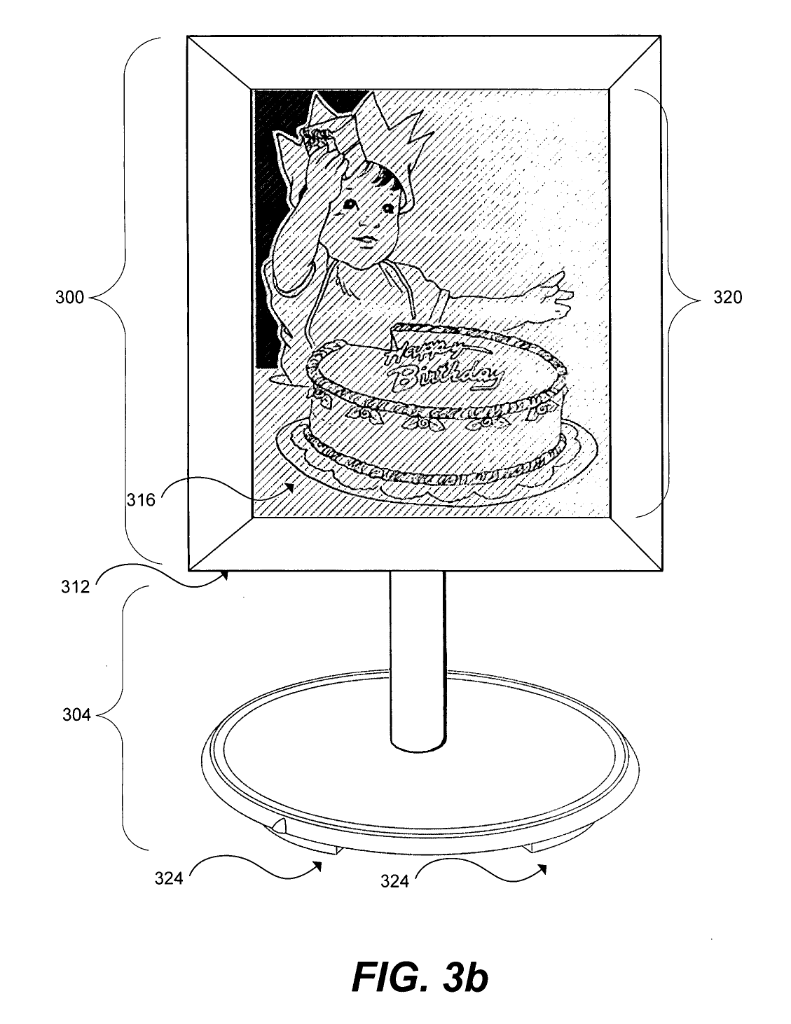

FIGS. 3a and 3b illustrate an aspect of a device which enables a consumer to display personalized information. The device includes a display mechanism 300 in which (or on which) the personalized information may be placed, and an attachment mechanism 304 that attaches the display mechanism to a vehicle by way of a base. The attachment mechanism 304 attaches to, and is detachable from, the base by way of feet 324, although other attachment mechanisms may be used. As shown in FIG. 3a, the display mechanism 300 includes a plate 312 attached to the attachment mechanism 304, and a cover 316. The personalized information 320, shown here as a photograph of a family member of the consumer, is placed between the plate 312 and the cover 316. Then, as shown in FIG. 3b, the cover 316 is placed over the personalized information 320 and attached to the plate 312. Since the cover 316 comprises a transparent element through which the personalized information 320 may be seen, it serves to protect the representation of the personalized information from weather or road damage without obscuring it from view. In alternative configurations, a cover and plate are pre-assembled, and a photograph or other personalized information bearing device is slid or snapped into place without moving the cover.

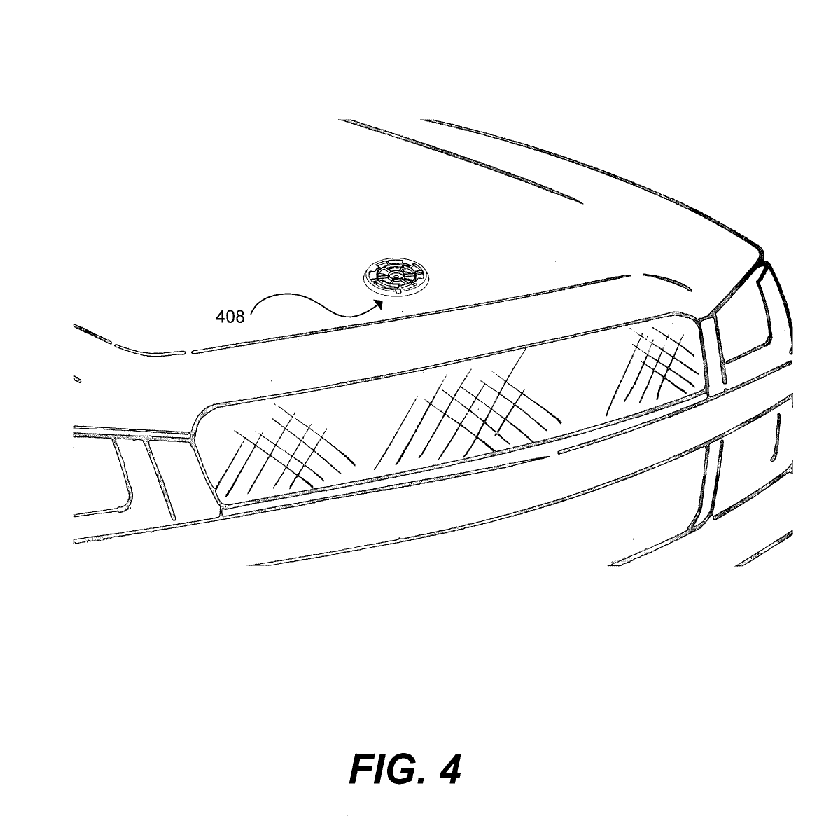

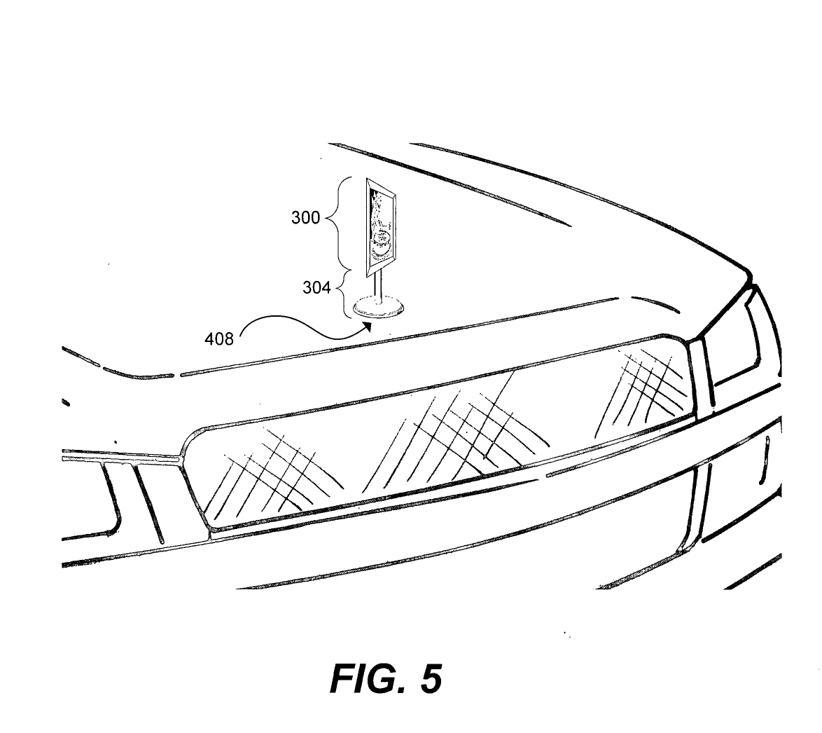

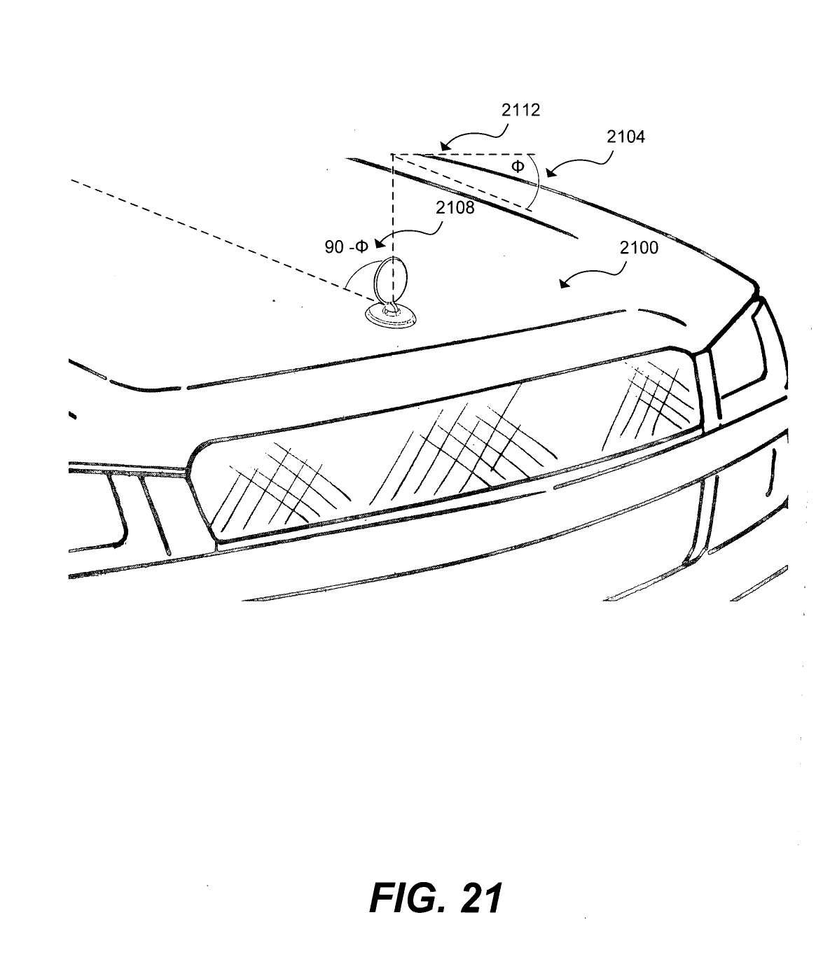

As shown in FIG. 4, a base 408 may be disposed at the hood of a car. Other vehicles, including as non-limiting examples cars, light trucks, sports utility vehicles, trucks, military vehicles, motorcycles, and boats, are suitable for use with the present subject matter. Other locations on the vehicle may also be used, including as non-limiting examples the dashboard of the vehicle, the inside of a window of the vehicle, the outside of a window of a vehicle, the roof of the vehicle, the hood of the vehicle, the trunk of the vehicle, the bumper of the vehicle, the tailgate of the vehicle, and the trailer hitch of the vehicle. When the consumer so desires, and as shown in FIG. 5, the attachment mechanism 304 may be attached to the base 408 at the vehicle to display the display mechanism 300. Note that a further, pivotable attachment mechanism is shown in FIG. 21, which will be described below.

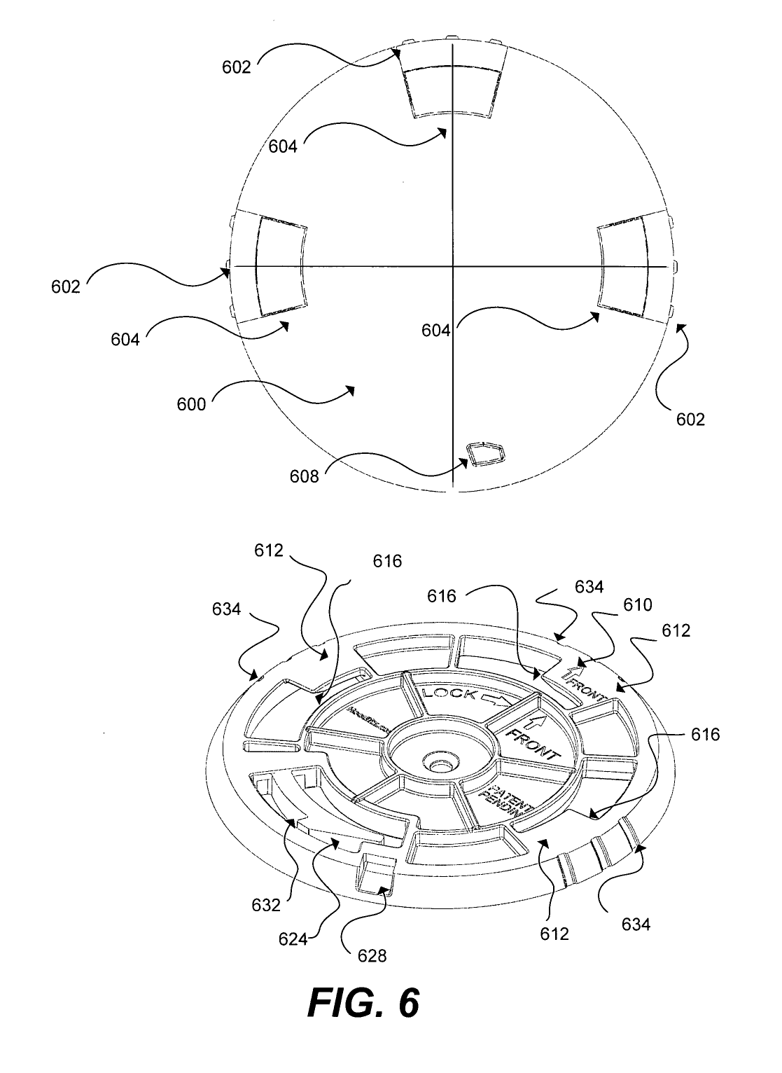

The attachment mechanism will now be described with reference to FIG. 6, although other attachment mechanisms may be used, and this is merely a non-limiting example of one attachment mechanism particularly well suited to use on a vehicle, and for repeated attachment and detachment, without succumbing to the stresses of vehicle use. The attachment mechanism 600, the underside of which is shown in FIG. 6, is provided with three feet 604 and one tab 608, although other numbers of feet and/or tabs are possible. When inserted, tab 608 comes in contact with a clip 624 disposed in the base 620 with an angled edge and a wide end 632. The base includes recesses 616 beneath, and defined by, extensions 612. The attachment mechanism 600 is rotated for insertion. When the feet 604 are fully turned into the recesses 616, the clip 624 springs closed, and the vertical spring tension of the clip 624 keeps the wide end 632 abutting the tab 608 and prevents the attachment mechanism 600 from being rotated in the opposite direction. The feet 604 abut the interior rear wall of each recess 616 and keep the mechanism 600 from rotating further in the initial direction. If removal is desired, a key may be inserted into the key-insertion opening 628 and engage the clip 624, opposing its tension and allowing the attachment mechanism 600 to rotate back until the feet 604 are no longer beneath the extensions 612, at which time the attachment mechanism 600 may be removed.

Optional finger ridges 602 provided on the outer edge of the attachment mechanism 600 may be used to grip the attachment mechanism 600 during rotation into or out of the base. Although three finger ridges are shown on three sides of the attachment mechanism, this is a non-limiting example, and different numbers, shapes, or configurations of ridges may be used to facilitate gripping and moving of the attachment mechanism. Alignment ridges 634 (which may be protrusions, indentations, or flat indicia) may be used on the base to aid in aligning the attachment mechanism 600 with the base, or in aligning the base with the vehicle or other surface on its first application thereto. To this end, additional alignment indicia 610 such as directional arrows may be provided as well. Although not shown in other embodiments, optional finger ridges 602 and optional alignment ridges 634 may be utilized on any of the various embodiments of display devices, attachment mechanisms, and bases disclosed herein.

The use of a key as described above is optional, however, and in alternative configurations the tab and clip may simply “snap in” to place with a given force F1 in a rotational direction R, and may “snap out” of place if moved with a given force F2>F1 in the opposite rotational direction −R. In this alternative configuration, no key is necessary, as the size and direction of force F2 are sufficient to release the attachment mechanism, which otherwise stays in place. In still more alternative configurations, F2 may be equal to, or less than, F1.

The attachment mechanism set forth above is only one kind of attachment mechanism well suited for repeated attachment to and detachment from a vehicle without succumbing to the stresses of vehicle use. However, other attachment mechanisms may be used with the present subject matter. As non-limiting examples of other attachment mechanisms, bases which are not circularly symmetric may be used, and may provide an advantage where the placement location of the base on the vehicle is not flat. For example, curved bases can be provided for curved hoods, and bases with a central recess can be provided for hoods with a central ridge. In general, bases with circular, elongated, and other shapes may be used, including elongated bases in which the attachment mechanism “slides in” from the front, back, or side, instead of “twisting in” as in FIG. 6. In addition, magnetic attachment mechanisms may be used. As a further non-limiting example, a magnetic base may be attached to a vehicle by adhesives, and a magnetic attachment mechanism may be used to attach a display device or other object to the base, and to detach it from the base. The display device or other object would be attached to the magnetic display device, and would be removed from the magnetic base when the consumer wishes to use a different display device, which would also be configured for attachment with a magnet.

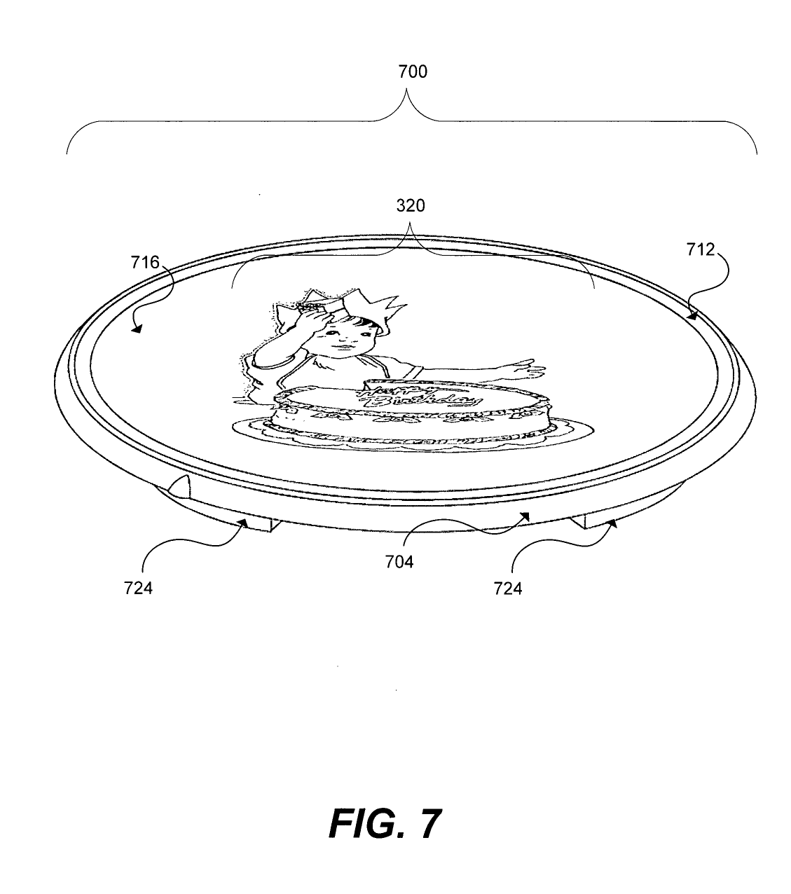

This is only one example of a device which can display personalized information on a vehicle. Other shapes and configurations of display devices may be used. An example of another shape is shown in FIG. 7, in which the personalized information 320, shown as a photograph of a family member, is provided on a circular or “medallion-shaped” display device 700, itself connected to an attachment mechanism 704 which again includes feet 724 for rotational insertion into a base. Again, the display device is envisioned as having a plate 712 in or on which the personalized information 320 is disposed, and a cover 716 through which the personalized information may be viewed. This is only one configuration, however, and alternatively the personalized information 320 may be printed directly onto the display device 700, or may be printed onto a plate which snaps directly into the display device, with no “cover” per se.

As the feet 724 are similarly configured in this aspect and in the aspect of FIG. 6, it is clear that either display device may be used with a base disposed on a vehicle (as previously shown in FIG. 4). It is envisioned that a consumer may own multiple display devices, many of different shapes or sizes, and each displaying different personalized information. As all the display devices have matching feet, they may all be used with the base, and may be interchanged at the consumer's whim or need.

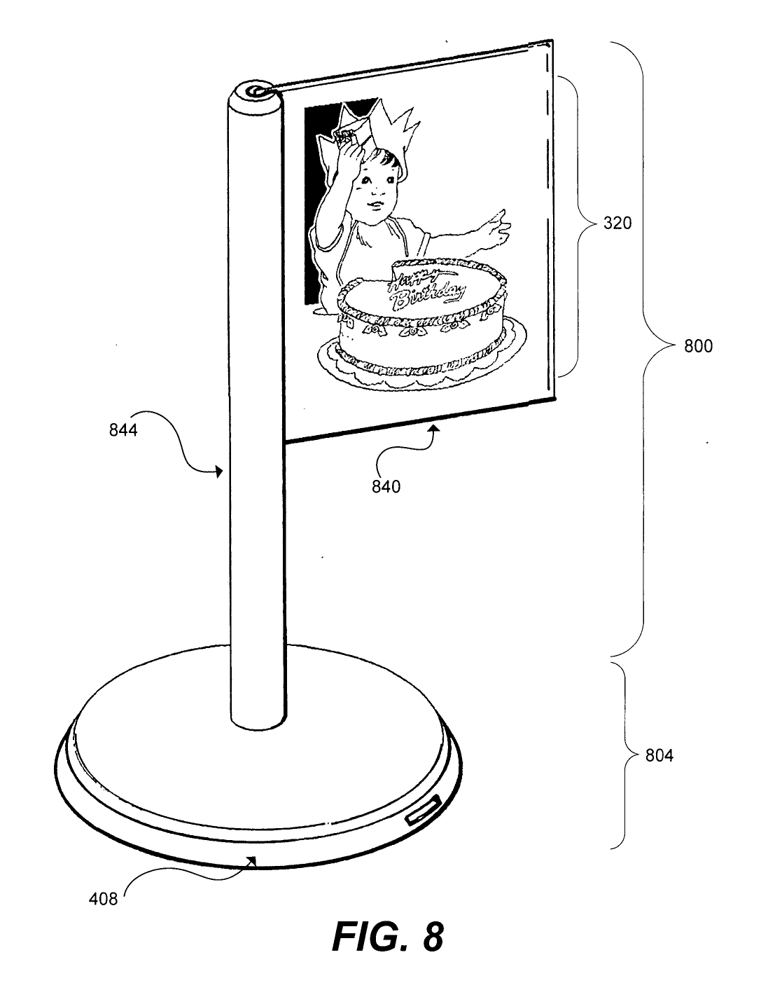

An example of another shape is shown in FIG. 8, in which the personalized information 320, again shown as a photograph of a family member, is provided on a banner or “flag-shaped” display device 800, itself connected to an attachment mechanism 804. Here, the feet are obscured, as the device has been rotationally inserted into a base 408. The display device is envisioned as having a flag 840 in or on which the personalized information 320 is disposed, and a pole 844 for supporting the flag 840. The flag may be provided preconfigured by the display device provider, or the consumer may print, stick (as in a sticker), or iron the personalized information onto a blank flag at home (provided to the consumer with the attachment mechanism), and then place it into the pole 844.

Other shapes, not shown in the present figures, can also be used to show personalized information, and include without limitation: moving figures with mechanical parts; dancing figures which dance to a particular song; dancing figures of school mascots which dance to school songs; illuminated objects; moving or illuminated objects which derive their power from batteries; moving or illuminated objects which derive their power from the vehicle's power system; or moving or illuminated objects which derive their power from solar cells.

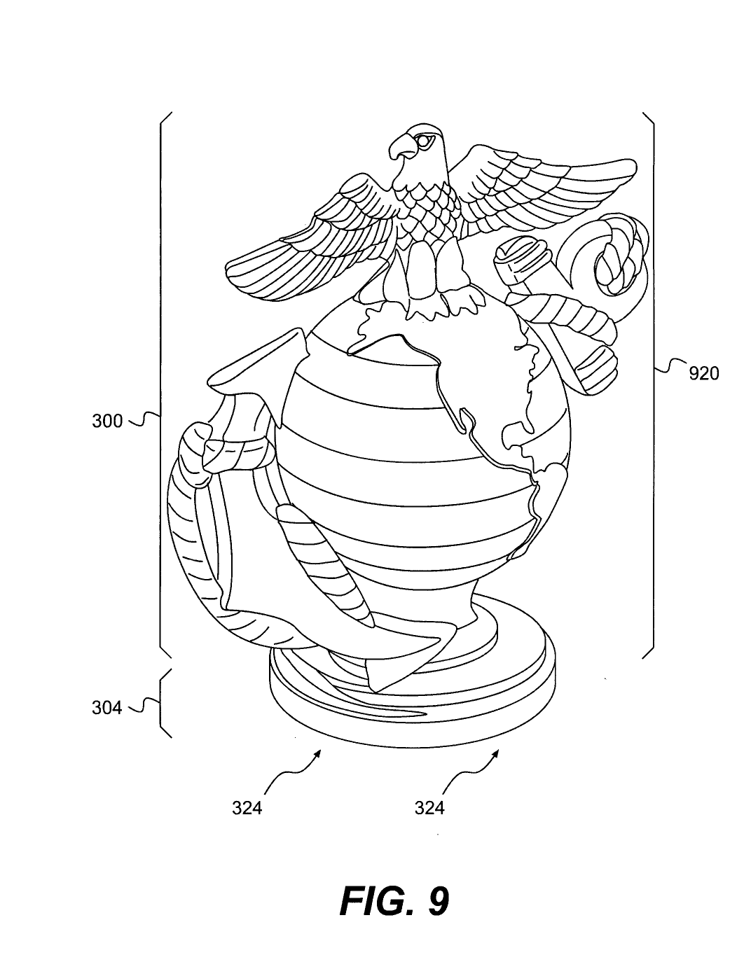

One advantage of a display device for displaying personalized information on a vehicle is that images or words with which the consumer identifies may be shown. For example, servicemen and servicewomen, and veterans, often wish to acknowledge their service in the military. An example of such a personalized display device is shown in FIG. 9, where personalized information representing military affiliation 920 is displayed by a display device 300 and attachment mechanism 304. Although not visible, feet 324 are disposed at the underside of attachment mechanism 304 for attachment to a base as described above. This three-dimensional military symbol is only one example of personalized information representing military affiliation, and such information may also or alternatively include a slogan, a photograph, a two-dimensional military symbol, a picture frame containing military-related indicia, a low-profile medallion displaying military-related indicia, a vertical medallion displaying military-related indicia, a representation of award or rank, and/or a flag displaying military-related indicia. This type of personalized information may be selected or provided by the consumer, or may be given by the military service branch or its supporters to the servicemen and servicewomen.

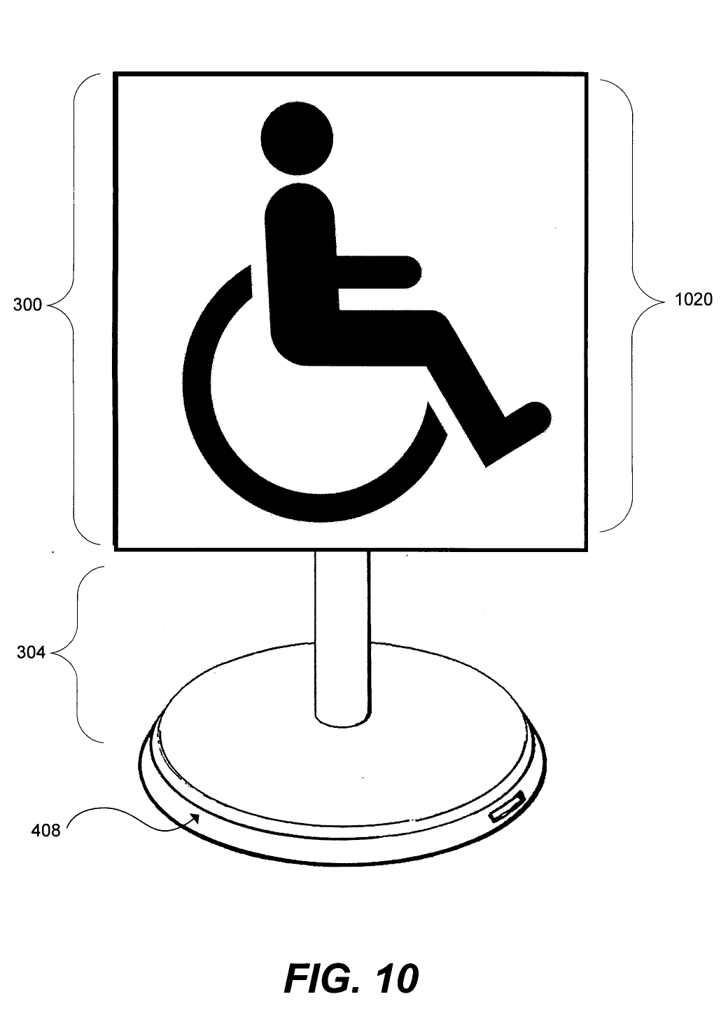

A personalized display device may also be used to identify an authorization. For example, a residential community may offer its residents a personalized display device which displays their permission to park in a certain area. Another such authorization may be a handicap parking permit, as shown in FIG. 10, where the authorization 1020 is shown at display device 300, attached by attachment mechanism 304 to base 408, which would presumably be disposed on a vehicle. Other authorizations include campus parking permits, parking permits generally, residential permits, entry permits, and other forms of authorized identification. The authorization may include electronics for identification, such as, without limitation, a radio transmitter, a bar code, an RFID chip (such as in an E-Z Pass), or other electronics hidden from view.

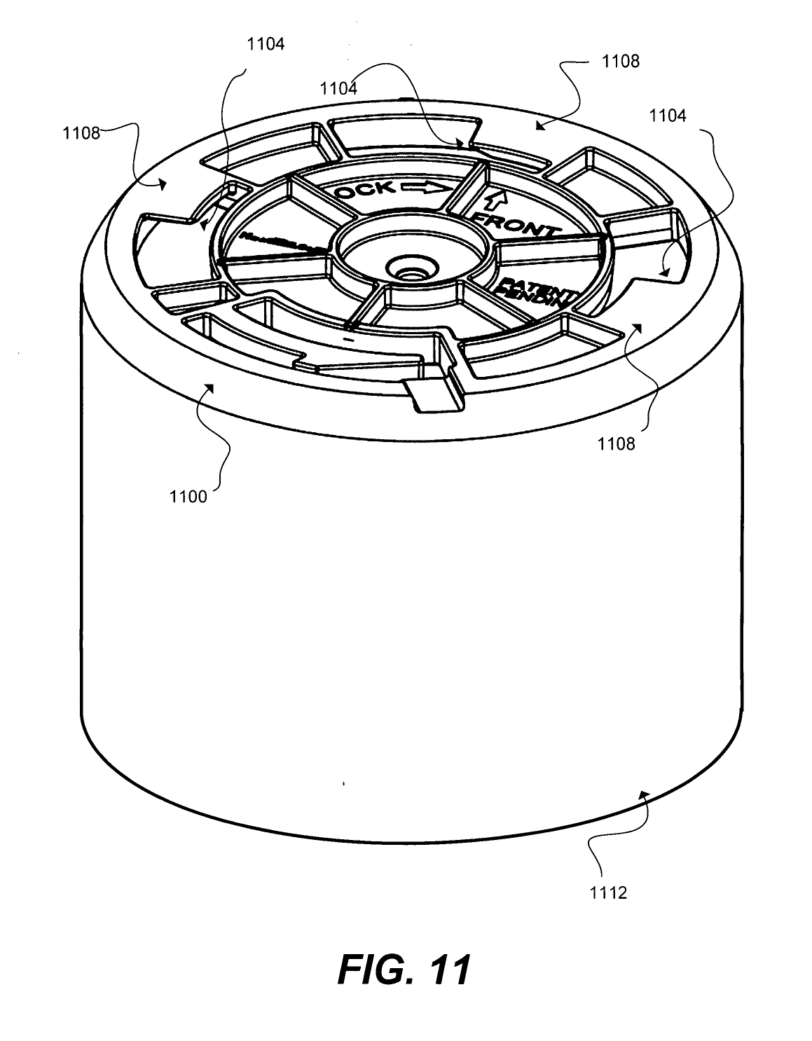

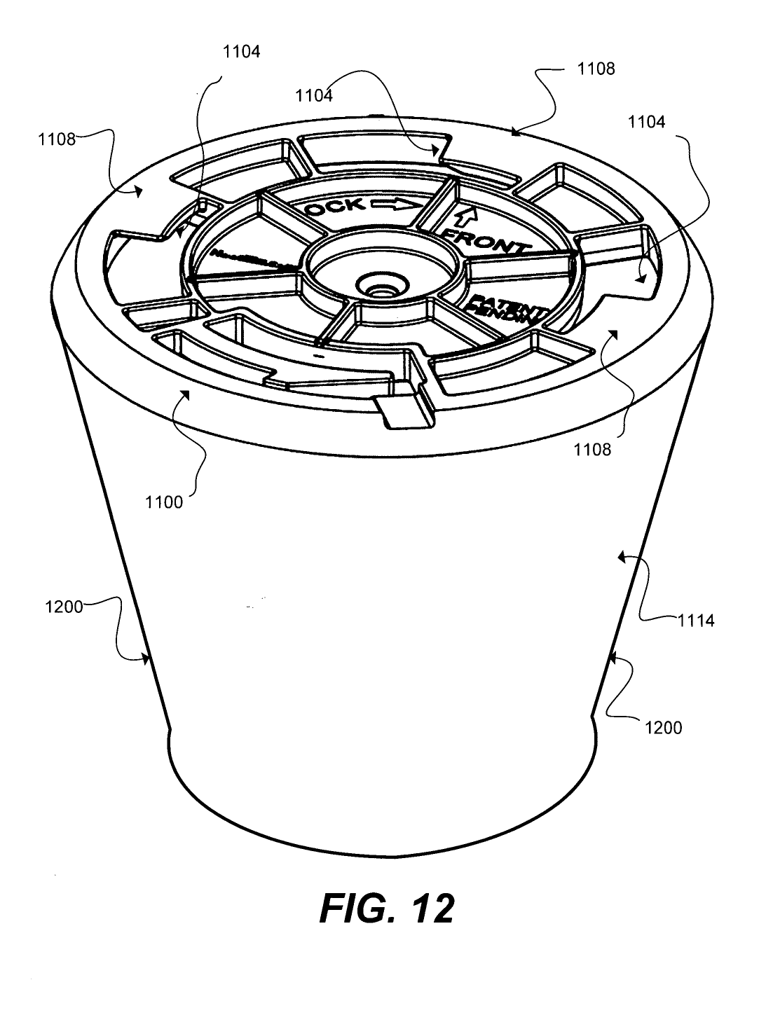

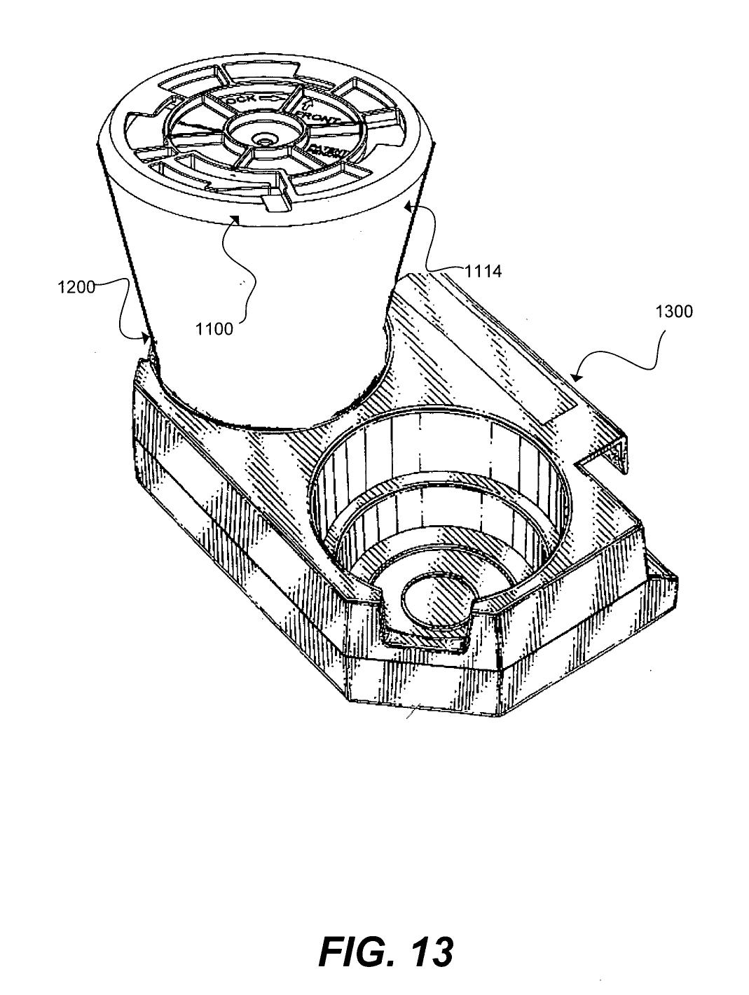

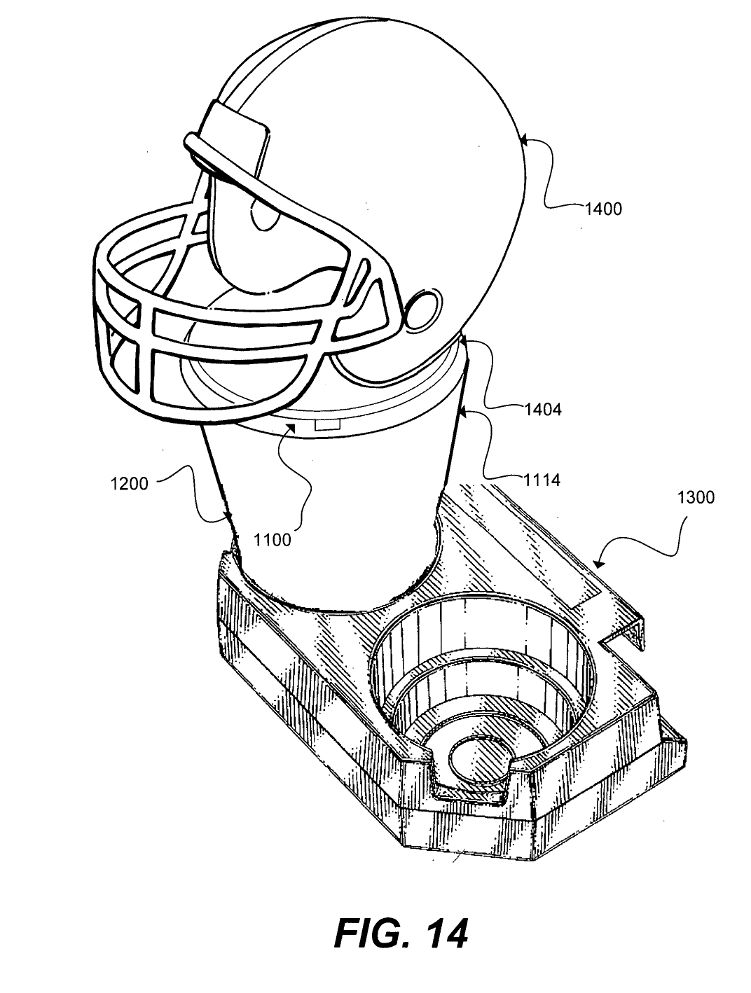

Another way to keep and display a display device according to the above description will now be described with reference to FIGS. 11-14. In FIG. 11, a base 1100, with recesses 1104 and extensions 1108 to receive the feet of the standardized attachment mechanism, includes a protrusion 1112 which extends downward. The protrusion 1112 may be hollow or weighted. The protrusion 1112 may be shaped for insertion into a cup rest of a vehicle. This may be accomplished by use of a cylindrical protrusion 1112 of appropriate constant diameter, or as shown in FIG. 12 by use of a tapered protrusion 1114 with angled sides 1200, although any shape compatible with a cup rest may be used. In FIG. 13, the base 1100 is shown placed in the cup rest 1300 of a vehicle, where the protrusion 1112 and tapered sides 1200 rest inside the space that a cup would occupy. Then, as shown in FIG. 14, a display device 1400 and attachment mechanism 1404 may be attached to the base 1100.

The base shown in FIGS. 11-14 serves a number of advantages. It keeps the display device in view, it allows the display device to easily be transferred into another vehicle which otherwise does not have a base yet disposed there, and it allows display of personalized information at an otherwise underutilized location of a vehicle, namely the cup rests, which may be disposed throughout the vehicle.

It is anticipated that such a cup rest configured base, having a standardized connection, may also be used with other modular components which, although not display devices, may nevertheless be desired to be placed at a cup rest, such as an iPod(® Apple Inc., Cupertino, Calif.) or personal media player holder and/or an FM transmitter, a portable DVD screen, a GPS device holder, a cell-phone holder, a garage door opener, or a game or toy. Such devices would be provided with an attachment mechanism according to the present design, and thus attach at a cup rest base, a dashboard base, or at any other base disposed inside the vehicle.

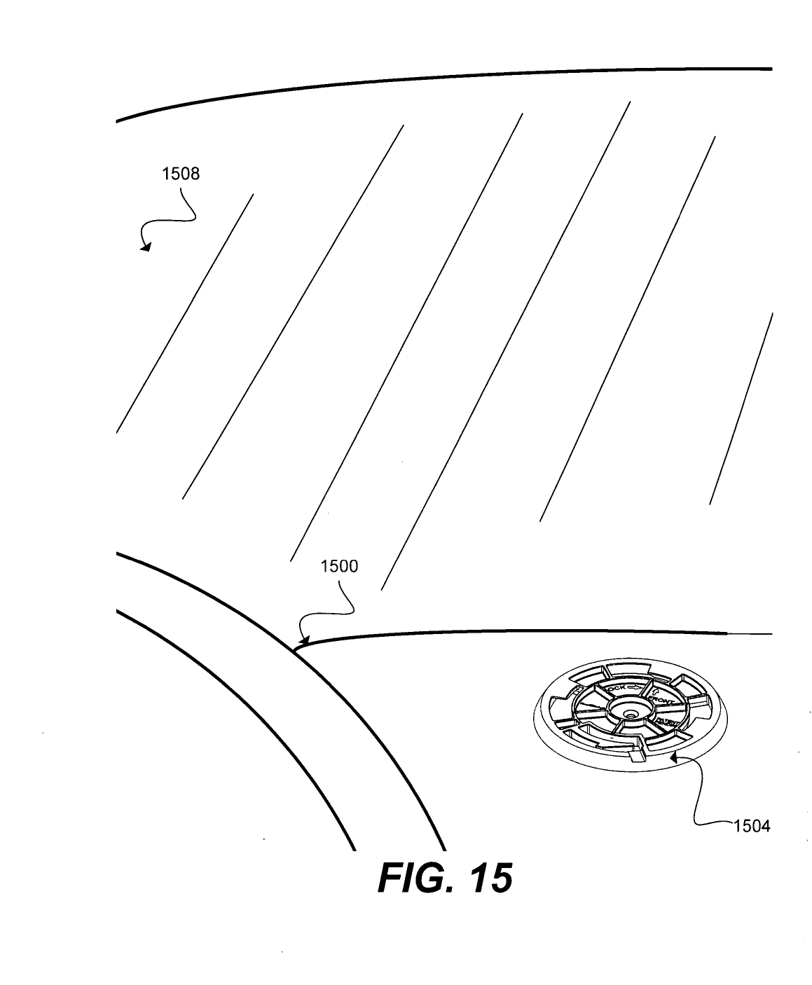

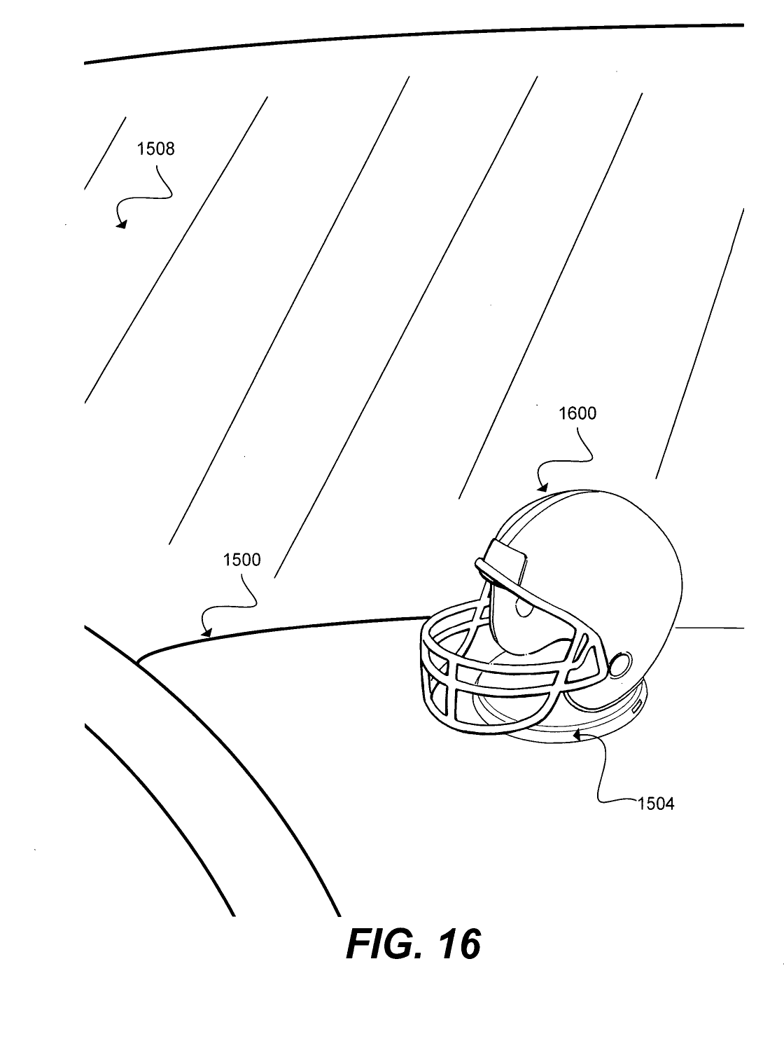

As noted above, it is presumed that a consumer will own a variety of display devices and advertisements which may be attached to and detached from one or more bases disposed on his or her vehicle. A natural concern is where and how to keep all of these display devices and advertisements. One solution is to attach multiple bases to the vehicle, at more than one location, such as at a dashboard of the vehicle; an inner side of a window of the vehicle; a roof of the vehicle; a hood of the vehicle; a trunk of the vehicle; a bumper of the vehicle; a tailgate of a vehicle; a trailer hitch of a vehicle; or inside a glove box of the vehicle. An example of this is shown in FIG. 15, where base 1504 has been attached on the dashboard 1500 of the vehicle, as seen from the inside of window 1508. As shown in FIG. 16, a display device 1600, here a three-dimensional figurine of a football helmet, may be attached to the base 1504 on dashboard 1500, and may thus be seen by individuals on both sides of window 1508. An alternative display device may be placed outside of the window on the hood of the car, and these may be interchanged as needed. Note that a base may be disposed inside a vehicle not only for storing a device but also simply for displaying the device inside the vehicle, when so desired.

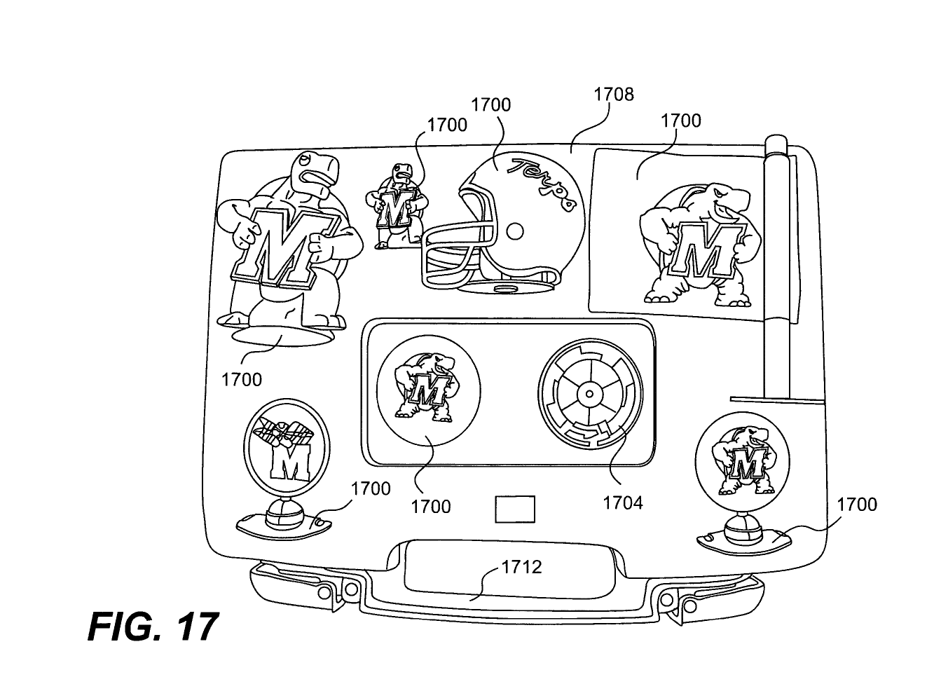

Another way to keep and display a display device according to the above description will now be described with reference to FIG. 17. Here, a plurality of display devices 1700 and a base 1704 are shown in a carrying case 1708 with a handle 1712. Such a case may be sold with a collection of display devices 1700, or may be provided for keeping display devices 1700 already purchased by the consumer. This is only one configuration of a carrying case, and smaller or larger carrying cases may be provided. When not in use, the display devices may be stowed in the carrying case, and the case kept in another part of the vehicle (as a non-limiting example, in the trunk).

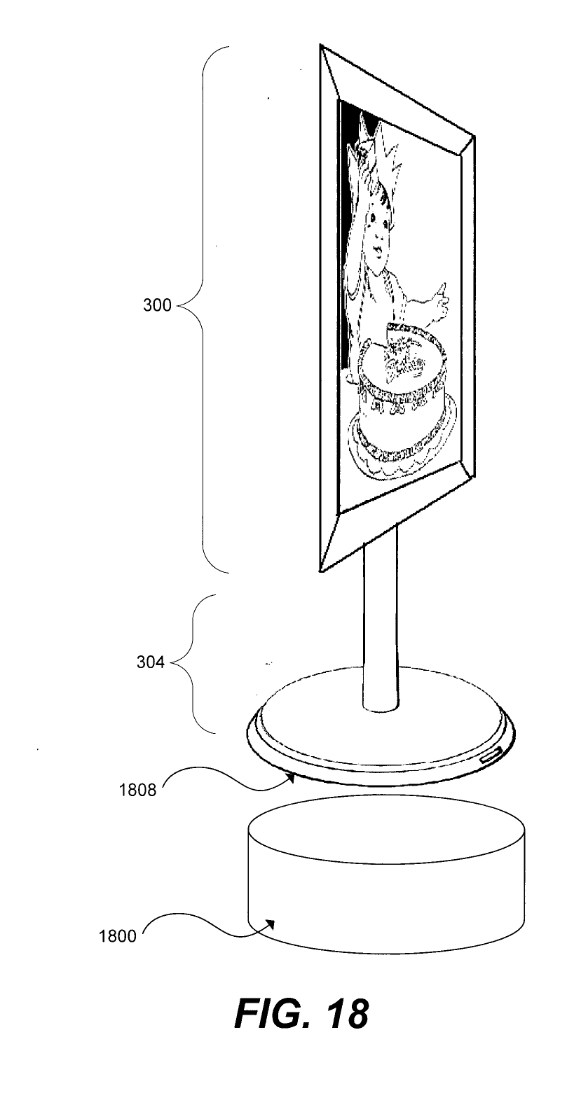

The base discussed in the aforementioned descriptions may be disposed at the vehicle in a number of ways. One such way is shown in FIG. 18, where attachment mechanism 304 is already connected to magnetized base 1808. Magnetized base 1808 may be placed on a surface of the vehicle (for example, on the hood), and a magnet 1800 may be disposed underneath the surface (for example, on the underside of the hood). The base is then held steady during insertion of the attachment mechanism 304, and display device 300 may thus be shown at the vehicle with limited modification thereto. The magnet may be a permanently strong magnet, a switchable magnet, an electromagnet, or any other kind of magnetic field generator. This is only one example of an attachment system, and others may be used, such as a light tack adhesive layer, screws, rivets, or a permanently bolted base. All of these base attachments still allow for the interchangeability of an attachment mechanism of a display device. Additionally, the base may come predisposed at the vehicle by the manufacturer.

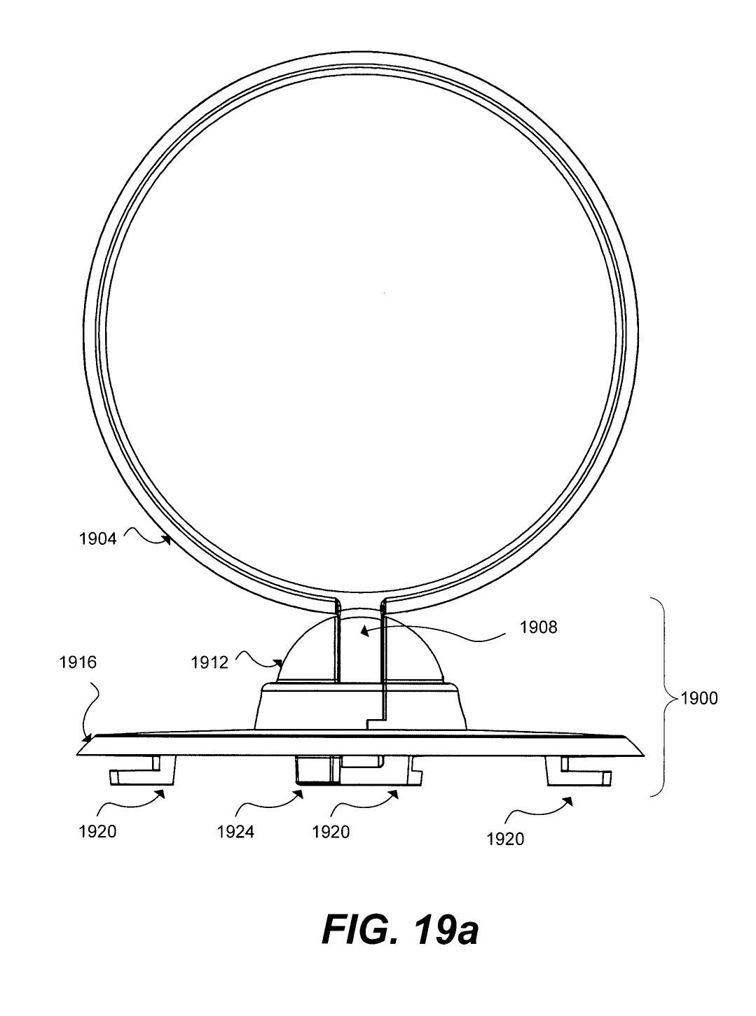

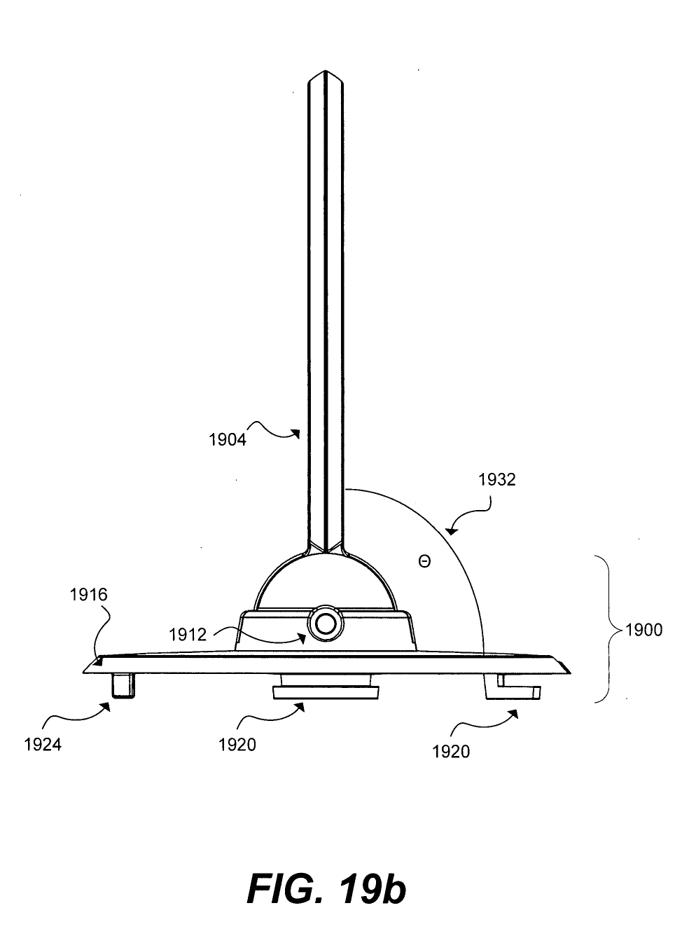

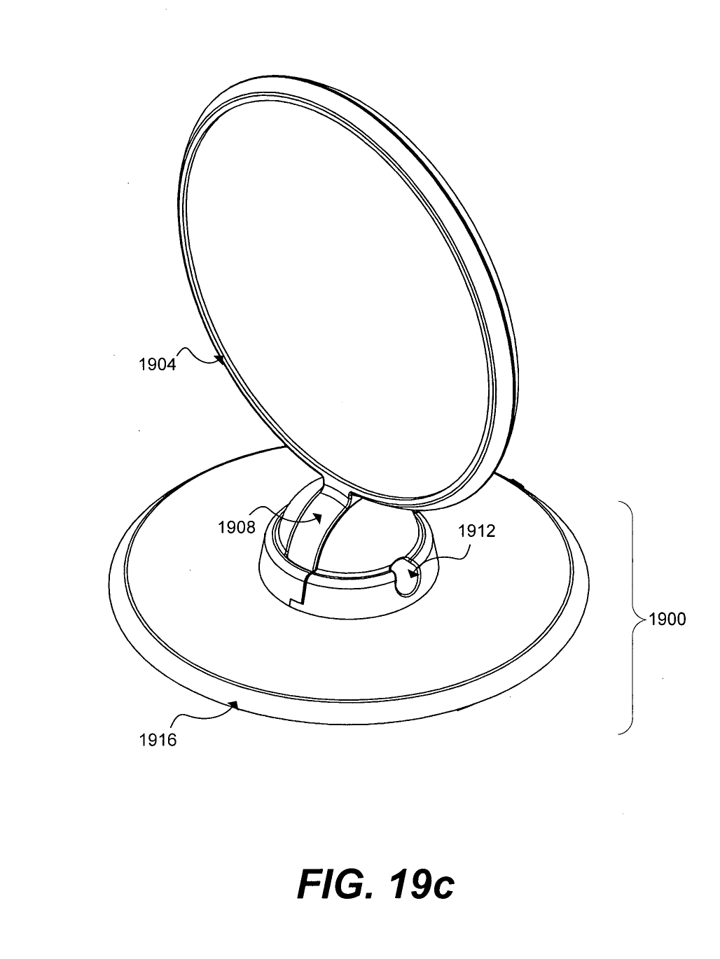

When considering the placement of a display device on a vehicle, it is recognized that not all surfaces of a vehicle are level, and that it may be desirable to provide a display device which may be pivoted for placement at a non-level surface. Such a device will now be described with reference to FIGS. 19-22. In these examples, a device is described which is compatible with the base set forth above, but importantly such techniques may be applied to any display device on a vehicle, and even to a traditional vehicle hood ornament, with or without the added features of a detachable base or personalized information at all.

As shown in FIG. 19a, FIG. 19b, and FIG. 19c, a display device 1904 includes an attachment mechanism 1900. The attachment mechanism 1900, which is detachable from a base, includes a support 1908 fixedly connected to the display device, and a pivotable connection 1912 such that the support is pivotably connectable to the vehicle at the surface. The attachment mechanism 1900 may attach by way of a base by use of feet 1920 and tab 1924 which protrude from plate 1916. When the pivotable connection 1912 is not pivoted, the display device is held upright, and angle 1932 is fixed at 90 degrees.

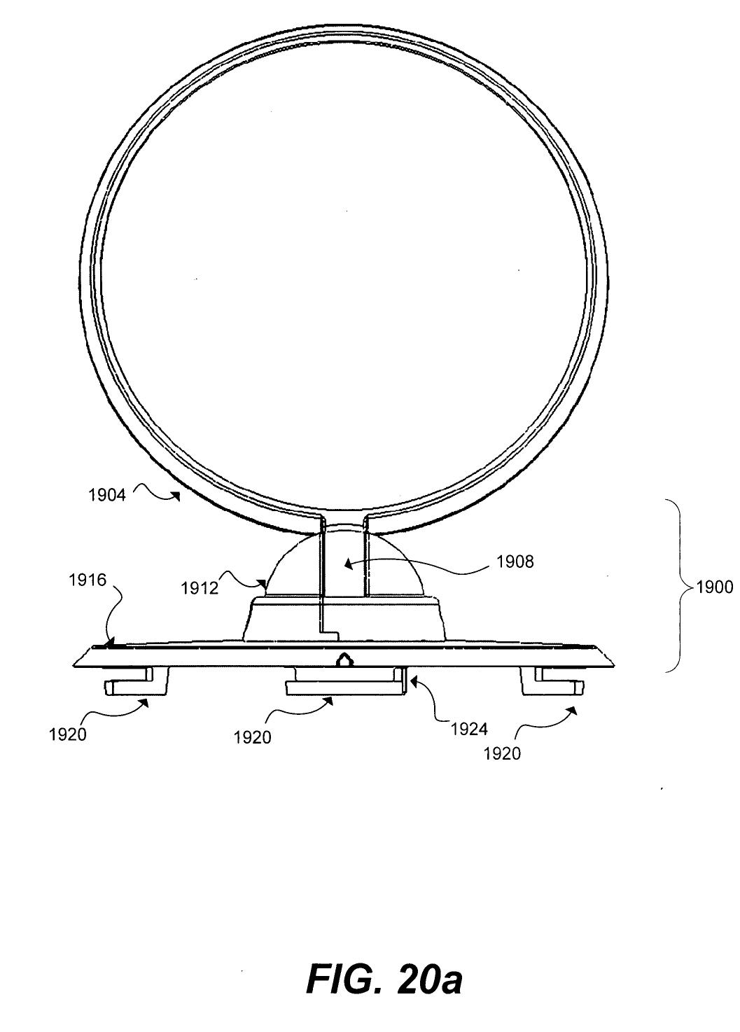

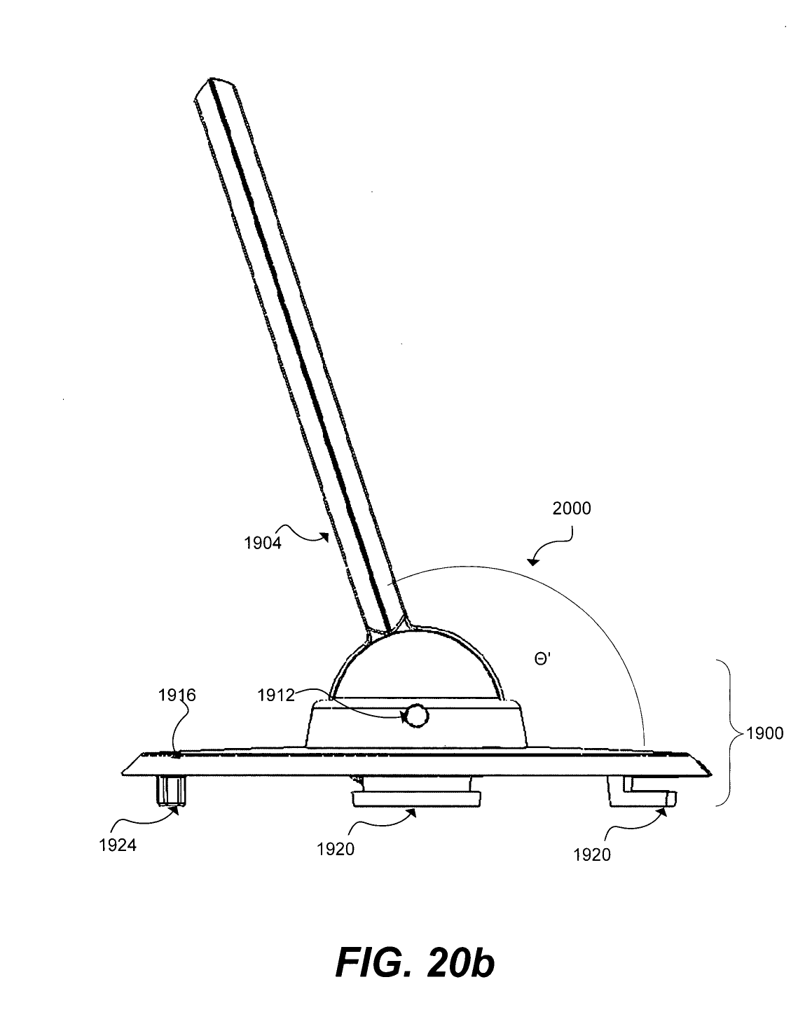

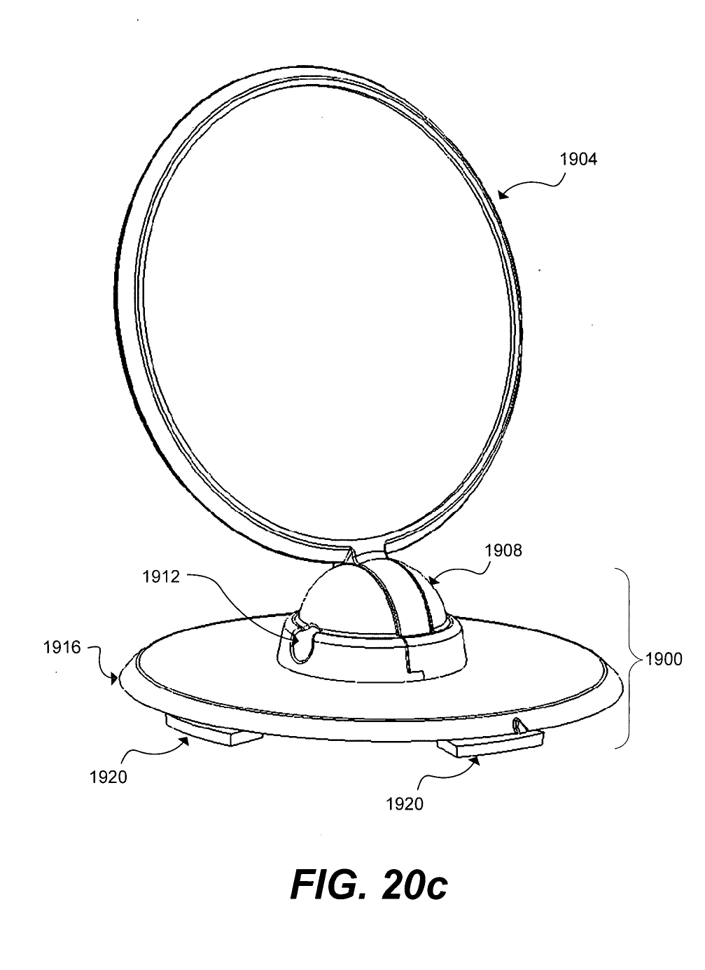

The device of FIGS. 19a, 19b, and 19c is shown pivoted in FIG. 20a, FIG. 20b, and FIG. 20c. Here, the display device has been pivoted to a new angle 2000, which is greater than 90 degrees on one side with respect to the surface of the vehicle. In this way, the pivotable connection 1912 of the plate 1916 and support 1908 allows the display device 1904 to pivot relative to a base.

The pivoted device is shown in FIG. 21 disposed at a non-level surface 2100 of a vehicle (here, the hood), although it may be disposed at any desired surface. As the hood 2100 is disposed at an angle Φ 2104 relative to the plane 2112 defined by the vehicle's wheels (and thus at an angle relative to an observer as well), the display device is pivoted to a complementary angle 2108 to angle 2104, and thus appears upright to an observer. This aesthetically pleasing configuration may be applied to any display device described herein.

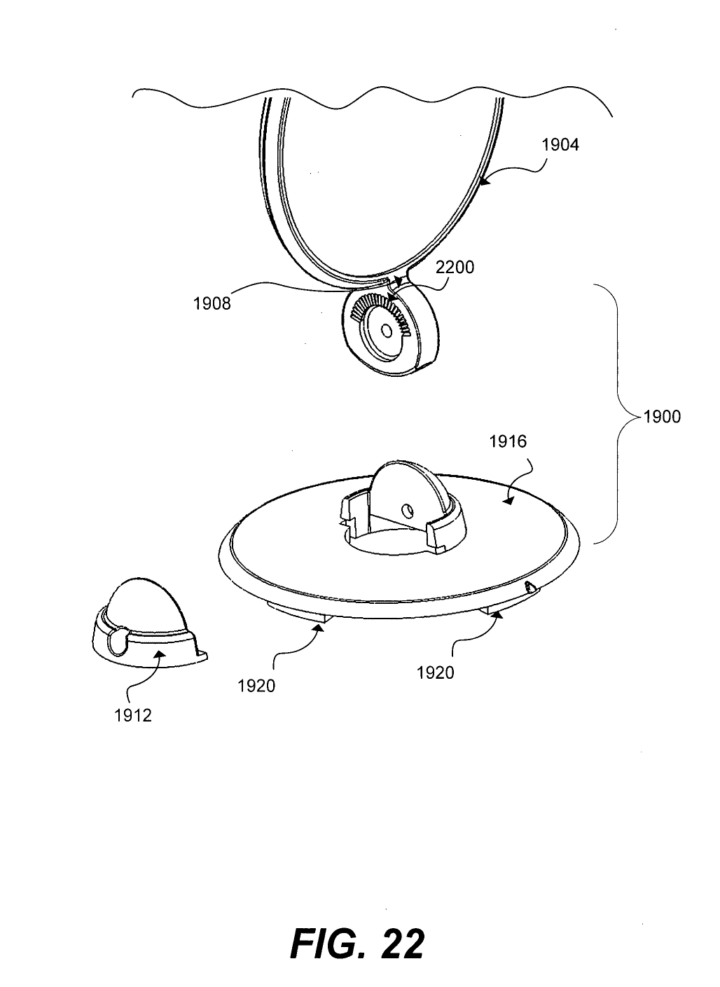

Such a pivoted device may be held at an angle in a number of ways, including by the tightening of a friction screw or by the use of pegs and recessed holes. A non-limiting example of a manner of holding the pivoted device at an angle is shown in FIG. 22. Here, display device 1904 and support 1908 are shown separated from pivotable connection 1912 and attachment mechanism 1900, which comprises plate 1916, feet 1920, and pivotable connection 1912. The support 1908 includes a ratcheting disk 2200, whose teeth mesh with corresponding teeth on the inside of pivotable connection 1912 (not shown). In this way, the display device 1904 may be “snapped” between a finite number of angles, and held at that angle by the meshed teeth and disk 2200. The support 1908 may thus be pivoted relative to the plate 1916, and thus the base to which it is attached, so that the display device may be displayed upright when the base is attached to a non-level surface of a vehicle.

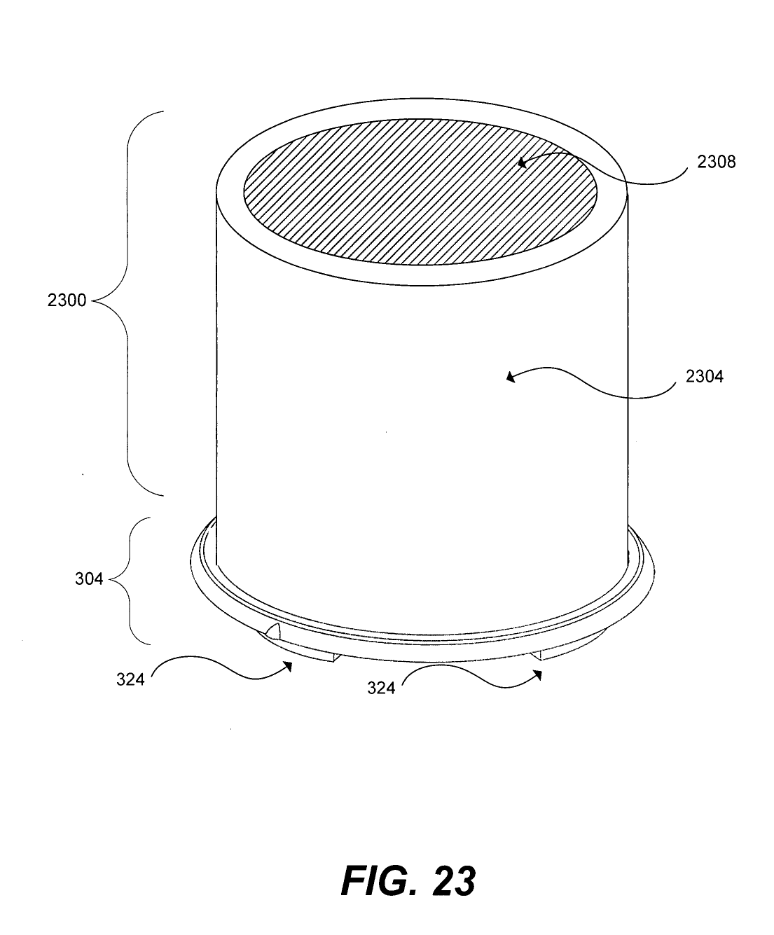

Stability is an important consideration in providing a consumer with a device which enables the display of personalized information at a vehicle. Accordingly, the presently disclosed systems and methods provide stable bases and attachment mechanisms by which the personalized information may be displayed. These bases and attachment mechanisms provide the strength needed to hold the personalized information upright under driving conditions. This stability lends itself to another novel use for the disclosed attachment mechanisms and those similar thereto, as shown in FIG. 23. Here, a cylindrical display device 2300 is shown, although other shaped display devices may be used. Any face or surface of the device 2300, such as face 2304, may be used to display personalized information. The device 2300 includes an attachment mechanism 304 as previously described, which itself includes feet 324. The attachment mechanism 304 provides stability to the device when used at or in a moving vehicle. Importantly, the device 2300 also includes a recess 2308, into which a can or cup may be placed. The device 2300 may thermally insulate, or mechanically heat or cool, the can or cup. Alternatively, a lightweight device 2300 may be chosen which simply supports the can or cup, and through which the sides of the can or cup may be seen. Although the device 2300 is described as having been preconfigured to display personalized information, it should be noted that under certain circumstances it may be advantageous to provide a consumer with a device 2300 without preconfigured personalization so that the consumer may place personalized information himself. In any case, the recess 2308 and attachment mechanism 304 together provide stability to any can or cup placed therein. It should be noted that a similar configuration may be used with other devices displaying personalized information and including a storage recess for something other than a can or cup. These devices may store, as non-limiting examples, food, change, keys, garage door openers, cellular phones, or portable audio or video players. The device need not be personalized if the consumer so desires.

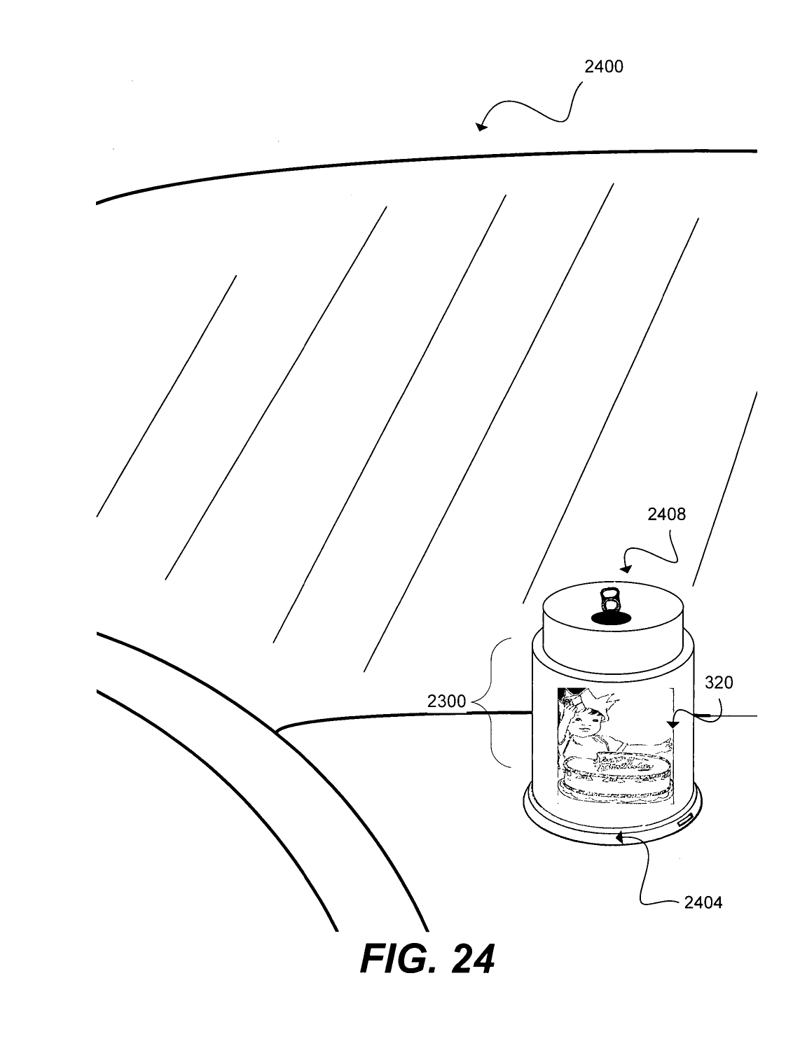

The device of FIG. 23 is shown in a non-limiting example of an operational environment in FIG. 24. Here, the device 2300 is shown attached to base 2404, disposed on an inside surface of a boat 2400. The use of a boat is merely one example of a vehicle in which stability is important; however, other vehicles may be used, as set forth in the preceding paragraphs. Here, the device 2300 is shown with personalized information 320 disposed thereon, and a can 2408 has been inserted into the recess. The can 2408 therefore is held in place with stability, even if the boat 2400 should turn or rock. An advantage to this configuration is that the base 2404 is compatible with the other personalized devices set forth above, and should the operator of the vehicle desire to display different personalized information (as a non-limiting example, the frame of FIG. 3), the device 2300 can be removed and the alternate device may be attached to the base, without removing the base 2404 from the surface of the boat 2400 or other vehicle.

The previous description of some aspects is provided to enable any person skilled in the art to make or use the present invention. Various modifications to these aspects will be readily apparent to those skilled in the art, and the generic principles defined herein may be applied to other aspects without departing from the spirit or scope of the invention. For example, one or more elements can be rearranged and/or combined, or additional elements may be added. Thus, the present invention is not intended to be limited to the aspects shown herein but is to be accorded the widest scope consistent with the principles and novel features disclosed herein.

What is claimed is:

1) An attachment mechanism that attaches an object to a surface of a vehicle, the attachment mechanism comprising:
a support fixedly connected to the object and pivotably connectable to the vehicle at the surface, such that the object may be held at a pivoted angle relative to the surface.

2) The attachment mechanism of claim 1, wherein the object is a display device.

3) The attachment mechanism of claim 2, wherein the attachment mechanism attaches the display device to the vehicle surface by way of a base, wherein the attachment mechanism is detachable from the base, the attachment mechanism further comprising:
a plate connected to the support; and
at least one foot connected to the plate, each of said at least one foot being feedable into a corresponding recess beneath an extension protruding from the base,
wherein the pivotable connection of the plate and support allows the display device to pivot relative to the base, and
wherein the support is pivotably connectable to the vehicle surface at the base, such that the display device may be held at a pivoted angle relative to the base.

4) The attachment mechanism of claim 3,
wherein the plate pivotably connects to the support by way of a ratcheting disk.

5) The attachment mechanism of claim 3,
wherein the support is pivoted relative to the base so that the display device may be displayed perpendicular to a plane defined by the vehicle's wheels when the base is attached to a vehicle surface that is not parallel to the plane defined by the vehicle's wheels.

6) A method of enabling a consumer to display information personalized to the consumer, the method comprising:
providing the consumer with a display device for displaying the personalized information; and
providing the consumer with an attachment mechanism that attaches said display device to a vehicle by way of a base affixed to the vehicle, wherein said attachment mechanism is detachable from the base.

7) The method of claim 6, the method comprising
placing the personalized information on or in the display device for the consumer.

8) The method of claim 6, the method further comprising
receiving a representation of the personalized information from the consumer; and
configuring the display device to display the personalized information, wherein
the step of providing the consumer with a display device occurs after the step of configuring the display device to display the personalized information.

9) The method of claim 8, wherein the representation includes digital data representing at least one piece of personalized information selected from the group consisting of: photographs, drawings, text, symbols, electronics, and combinations thereof.

10) The method of claim 8, the method comprising:
providing a web site at which the consumer may upload digital data representing at least one piece of personalized information.

11) The method of claim 6, wherein the consumer places the personalized information on or in the display device.

12) The method of claim 11, the method comprising
receiving a first representation of the personalized information from the consumer; and
providing the consumer with a second representation of the personalized information, the second representation configured for placement on or in the display device, wherein
the step of providing the consumer with the display device occurs before the consumer places the personalized information on or in the display device.

13) The method of claim 6, wherein the display device is selected from the group consisting of: picture frame; low-profile medallion; vertical medallion; flag; three-dimensional figure; and combinations thereof.

14) The method of claim 6, wherein the personalized information represents military affiliation.

15) The method of claim 14, wherein the display device is selected from the group consisting of: three-dimensional military symbol; two-dimensional military symbol; picture frame containing military-related indicia; low-profile medallion displaying military-related indicia; vertical medallion displaying military-related indicia; representation of award or rank, flag displaying military-related indicia; and combinations thereof.

16) The method of claim 6, wherein the personalized information represents an authorization.

17) The method of claim 16, wherein the authorization is selected from the group consisting of: handicap parking permit; campus parking permit; parking permit; residential permit; entry permit; authorized identification, RFID identification.

18) The method of claim 6, wherein the base is disposed at a location of the vehicle selected from the group consisting of: a dashboard; an inner side of a window; an outer side of a window; a roof; a hood; a trunk; a bumper; a tailgate; a trailer hitch.

19) The method of claim 6, wherein the vehicle is selected from the group consisting of: a car; a light truck; a sports utility vehicle; a truck; a military vehicle; a motorcycle; a boat.

20) The method of claim 6, wherein the display device comprises a recess configured to hold an object.

21) A device which enables a consumer to display information personalized to the consumer, the device comprising:
a display mechanism in which or on which the personalized information may be placed, and
an attachment mechanism that attaches said advertisement to a vehicle by way of a base affixed to the vehicle, wherein
said attachment mechanism is detachable from the base.

22) The device of claim 21, the display mechanism comprising:
a plate attached to the attachment mechanism; and
a cover, wherein
the personalized information is placed between the plate and the cover, and
wherein the cover comprises a transparent element through which the personalized information may be seen.

23) The device of claim 21, wherein the base is attached to the vehicle by way of a magnet.
